(19) United States
(12) Patent Application Publication
(10) Pub. No.: US 2025/0314096 A1
(43) Pub. Date: Oct. 9, 2025

(54) HIGH SECURITY COMBINATION PADLOCK AND LOCKING SHACKLE WITH OPENING AND RESET PLATE MECHANISM

(71) Applicant: The Sun Lock Company Limited, Tuen Mun (HK)

(72) Inventor: Karl LAI, Tai Po (HK)

(21) Appl. No.: 19/083,352

(22) Filed: Mar. 18, 2025

Related U.S. Application Data
(60) Provisional application No. 63/574,209, filed on Apr. 3, 2024.

(51) Int. Cl. E05B 37/00; E05B 37/02

(52) U.S. Cl. CPC E05B 37/0068; E05B 37/0058; E05B 37/025

(57) ABSTRACT

A padlock according to an exemplary aspect of the present invention incorporates an improved false gate mechanism which provides nine false gates and one true gate. The padlock may contain a rotatory turning knob to operate the padlock to an unlocked mode. The rotary turning knob further increases the difficulty of decoding and picking the padlock, because the unauthorized user must use turning torque to pick the true gate of the padlock. The padlock may also include a reset plate which when the padlock to be in the unlocked mode, the reset plate may be slid to allow the padlock into a reset mode in which the correct code combination of the padlock may be reset and/or reconfigured.

### CROSS-REFERENCE TO RELATED APPLICATIONS

This application claims priority to U.S. Provisional Appl. No. 63/574,209 filed Apr. 3, 2024, which is hereby incorporated by reference in its entirety.

### BACKGROUND OF THE INVENTION

### 1. Field of the Invention

The present invention generally relates to padlocks, and more particularly to a combination warehouse padlock having a locking shackle with an opening and reset plate mechanism, and an advanced anti-picking mechanism which is enclosed in a lock body/housing.

### 2. Related Art

The padlock disclosed in U.S. Pat. No. 6,883,355, which is hereby incorporated by reference in its entirety, has three extended fins on the clutches with three true gates in the lock body. However, the effectiveness of the padlock is very limited as from a lock picking perspective, as there are only five of ten chances to locate the true opening position which can quite easily be determined and the padlock opened. Therefore, what is desired is a new false gate mechanism in order to increase the difficulty of an unauthorized user decoding the correct code combination of the padlock.

### SUMMARY OF THE INVENTION

A padlock according to an exemplary aspect of the present invention incorporates an improved false gate mechanism which provides nine false gates and one true gate. Such feature will cause an unauthorized user to receive a “clicking” sound feedback for every number which could confuse the unauthorized user from determining the true gate. This will make the combination mechanism of the padlock harder to decode and pick. The padlock may contain a rotatory turning knob to operate the padlock to an unlocked mode. The rotary turning knob further increases the difficulty of decoding and picking the padlock, because the unauthorized user must use turning torque to pick the true gate of the padlock. The padlock may also include a reset plate which when the padlock is operated to the unlocked mode, the reset plate may be slid to allow the padlock to be operated into a reset mode in which the correct code combination of the padlock may be reset and/or reconfigured.

According to this and other exemplary aspects of the present invention, a padlock is provided that may include a lock body having a front body side and a rear body side configured to form an enclosure for at least a portion of the padlock, a shackle moveable between a locked mode position and an unlocked mode position, and when the shackle is in the locked mode position the padlock is in a locked mode, and when the shackle is in the unlocked mode position the padlock is in an unlocked mode, a combination mechanism that may include a set of clutches, each clutch of the set of clutches may include a plurality of false gates and at least one opening channel, the combination mechanism may also include a dial operatively connected to each clutch the set of clutches.

According to this and other exemplary aspects of the present invention, the combination mechanism may include a spindle having at least one protrusion for each clutch of the set of clutches, the at least one opening channel of each clutch is configured to control movement of the spindle allowing each protrusion of the spindle to pass at least partially through the opening channel of the corresponding clutch to operate the padlock to the unlocked mode or inhibiting movement of at least one of the one or more of the protrusions by at least one of the false gates of a clutch corresponding to the at least one protrusion.

According to this and other exemplary aspects of the present invention, the padlock may also include a bolt having one end configured to engage to the shackle and the other end configured to engage the combination mechanism.

According to this and other exemplary aspects of the present invention, the padlock combination mechanism may also include a turning knob operatively coupled to the spindle and configured for rotational movement at least partially within the lock body of the padlock, and the turning knob is further configured to allow movement of the shackle from the locked mode position to the unlocked mode position.

According to this and other exemplary aspects of the present invention, the turning knob may include one or more knob slopes and the spindle may include one or more spindle slopes configured to engage with the one or more knob slopes of the turning knob when the padlock is in the locked mode, rotation of the turning knob is configured to disengage the one or more knob slopes of the turning knob from the one or more spindle slopes of the spindle and cause rectilinear movement of the spindle in a spindle direction substantially parallel to an axis of rotation of the turning knob.

According to this and other exemplary aspects of the present invention, when the opening-channel of each of the clutches are fully aligned with the corresponding protrusions of the spindle each protrusion of the spindle is configured to pass at least partially through the opening channel of the corresponding clutch to operate the padlock to the unlocked mode.

According to this and other exemplary aspects of the present invention, if at least one of the opening channels are not aligned to the corresponding protrusions of the spindle, then the turning knob cannot cause rectilinear movement of the spindle in the spindle direction as a result of interaction between the slopes of the turning knob and the spindle.

According to this and other exemplary aspects of the present invention, the turning knob may also include an opening slot configured to receive the other end of the bolt that is configured to engage the combination mechanism, when the other end of the bolt is received within the opening slot of the turning knob the bolt end configured to engage to the shackle is disengaged from a bolt-cutout of the shackle, whereby the shackle may be moved rectilinearly from the locked mode position to the unlocked mode position.

According to this and other exemplary aspects of the present invention, the opening slot of the turning knob is formed in a locking surface of the knob, in the locked mode of the padlock the locking surface is engaged with the other end of the bolt, and when the turning knob is rotated the opening slot is configured for engagement with the other end of the bolt so as to allow operation of the padlock to the unlocked mode.

According to this and other exemplary aspects of the present invention, the spindle may also include a spindle flat wall formed on an end of each of the spindle slopes, and the turning knob may also include a turning knob flat wall formed on an end of each of the knob slopes, disengagement of the one or more knob slopes of the turning knob from the one or more spindle slopes of the spindle and cause engagement between the corresponding spindle flat walls and the turning knob flat walls and rectilinear movement of the spindle in the spindle direction.

According to this and other exemplary aspects of the present invention, the padlock may also include a reset button configured to control the padlock from the unlocked mode to a reset mode, wherein the reset button may include at least one tail configured to engage to a reset-knob-fin-slot of the lock body such that a user of the padlock could have both hands free from depressing the reset button while the padlock is in the reset mode.

According to this and other exemplary aspects of the present invention, when the padlock is in the reset mode, the reset button is configured for depression and rotation so as to allow the at least one tail to engage to the reset-knob-fin-slot of the lock body, depression of the reset button is configured to cause disengagement of each of the extended fins of each of the clutches from the teeth of the dials and engagement of each of the extended fins to a corresponding extended fin cutout in the lock body to prevent any rotational movement of the clutches.

According to this and other exemplary aspects of the present invention, the padlock may also include a reset plate assembled to the lock body, the reset plate is configured to cover up the reset button to avoid accidental change of a correct code combination of the combination mechanism, and to prevent the padlock from being decoded by depressing the reset button to trying to decode the correct code combination.

According to this and other exemplary aspects of the present invention, the padlock may also include a reset-control-bolt configured for engagement with the shackle when the shackle is in the locked mode position, and wherein the reset plate contains a reset bolt-receiving-cutout to receive the reset-control-bolt to control the movement of the reset plate.

According to this and other exemplary aspects of the present invention, when the shackle is in the locked mode position a shackle-edge of the reset-control-bolt is configured to contact the shackle, and the reset-control-bolt is configured to engage to the reset bolt-receiving cutout of the reset plate to prevent the reset plate from being moved to expose the reset button.

According to this and other exemplary aspects of the present invention, when the shackle is in the unlocked mode position a shackle-edge of the reset-control-bolt is configured to move in a direction towards the shackle when the reset plate is moved to expose the reset button, and a rounded-edge of the reset-control bolt is configured to be disengaged from the reset bolt-receiving-cutout of the reset plate when the reset plate is moved to expose the reset button.

According to this and other exemplary aspects of the present invention, the reset plate can only be moved when the padlock is in the unlocked mode and the shackle is in the unlocked mode position, the reset-control bolt is configured for movement in a direction substantially parallel to the movement of the shackle from the locked mode position to the unlocked mode position, and the reset plate is configured for movement in a direction substantially perpendicular to the movement of the shackle from the locked mode position to the unlocked mode position.

According to this and other exemplary aspects of the present invention, after resetting of a correct code combination of the combination mechanism of the padlock, the reset button is released, then the user could slide the reset plate from a reset state back to a lock state then a reset bolt-receiving-cutout from the reset plate will align back to a rounded-edge of a reset-control-bolt, the reset-control-bolt has a spring which will urge the rounded-edge toward the reset bolt-receiving-cutout, when the shackle is operated from the unlocked mode position to the locked mode position a tail of the shackle is configured to contact a shackle-edge of the reset-control bolt to cause engagement of the rounded-edge of the reset-control bolt with the reset bolt-receiving-cutout.

According to this and other exemplary aspects of the present invention, when the padlock is in the reset mode, after resetting and/or reconfiguring the correct code combination the user can rotate the reset button counter rotation to let the tail of the reset button disengage from the reset-knob-fin-slot of the lock body and a spindle spring will force the clutches and the reset button back from a reset mode position to an unlocked mode position, and the new correct code combination has been set when the reset plate is in the unlocked mode position and the shackle is in the unlocked mode position.

According to this and other exemplary aspects of the present invention, the padlock may be operated from the unlocked mode to the reset mode when the bolt is engaged to the opening slot of the turning knob to allow the shackle to be in the unlocked mode position allowing a reset-control-bolt to move rectilinearly and a reset plate to be slid open exposing a reset button.

According to this and other exemplary aspects of the present invention, the turning knob may also include an anti-drill peg hole configured for receipt of an anti-drill peg, and the anti-drill peg is configured to resist drilling of the turning knob from outside.

According to this and other exemplary aspects of the present invention, the turning knob may also include a thinner diameter weaken point such that a force applied to the turning knob in the locked mode, will cause the thinner diameter weaken point to break apart protecting the spindle from being forced to turn and operate the padlock to the unlocked mode.

According to this and other exemplary aspects of the present invention, the turning knob may also include a reinforcement peg hole for receipt of a reinforcement peg, the hardened reinforcement peg will contact the bolt to improve the contact strength between the bolt and the reinforcement peg.

According to this and other exemplary aspects of the present invention, that padlock may also include a protection cover formed from a hardened steel material configured to resist a sawing attack, the protection cover at least partially encloses the front body side and the rear body side of the padlock.

The reference numbers and corresponding elements are summarized below:

| | |
|---|---|
| 10 padlock | 70 spindle |
| 20 front body side | 71 slopes |
| 21 shackle hole | 72 flat-wall |
| 22 shackle-catcher | 73 protrusion |
| 23 bolt-hole | 80 clutch |
| 24 knob-receiving hole | 81 opening-channel |
| 25 spindle hole | 82 false gates |
| 26 clutch hole | 83 extended-fin |
| 27 extended-fin-cutout | 90 dial |
| 28 dial hole | 91 teeth |
| 29 reset-knob-fin-slot | 92 ratchet-feeling-cutout |
| 20a reset-plate slot | 100 reset button |
| 20b recode-bolt-cutout | 101 tails |
| 30 rear body side | 102 slot |
| 31 shackle hole | 103 spindle-receiving-cutout |
| 32 shackle-catcher | 110 reset plate |
| 33 bolt-hole | 111 slide-button |
| 34 knob-receiving hole | 112 edges |
| 35 spindle hole | 113 reset bolt-receiving-cutout |
| 36 clutch hole | 120 reset-control-bolt |
| 37 extended-fin-cutout | 121 rounded-edge |
| 38 dial hole | 122 shackle-edge |
| 39 reset-knob-fin-slot | 130 spindle spring |
| 30a reset-plate slot | 140 reset-control-bolt spring |
| 30b recode-control-bolt-cutout | 150 separation-ring |
| 40 shackle | 160 ratchet plate |
| 41 grabbing-zone | 170 cover. |
| 42 long-cutout | 180 reinforcement peg |
| 43 bolt cutout | 190 anti-drill peg |
| 44 tail | 260 turning knob |
| 50 bolt | 261 grabbing area |
| 51 shackle-side | 262 opening slot |
| 52 knob-side | 263 slopes |
| 60 turning knob | 264 flat wall |
| 61 grabbing area | 265 knob-bigger-diameter |
| 62 opening slot | 266 locking-surface |
| 63 slopes | 267 anti-drill-peg hole |
| 64 flat wall | 268 thinner diameter weaken point |
| 65 knob-bigger-diameter | 269 reinforcement peg hole |
| 66 locking-surface | |

### BRIEF DESCRIPTION OF THE DRAWINGS

For a fuller understanding of the nature and object of the present invention, reference should be had to the following detailed description taken in connection with the accompanying drawings, in which:

FIG. 1A is a partial cross-sectional front view of an exemplary padlock according to an aspect of the invention in a locked mode with an exemplary front body side removed;

FIG. 1B is a partial cross-sectional rear view of the exemplary padlock with an exemplary rear body side removed;

FIG. 2 is a perspective rear view of the exemplary front body side configured for use with the exemplary padlock according to an aspect of the present invention;

FIG. 3 is a perspective rear view of the exemplary rear body side configured for use with the exemplary padlock according to an aspect of the present invention;

FIG. 4 is a perspective view of an exemplary shackle configured for use with the exemplary padlock according to an aspect of the present invention;

FIG. 5 is a perspective view of an exemplary bolt configured for use with the exemplary padlock according to an aspect of the present invention;

FIG. 6 is a perspective view of an exemplary turning knob configured for use with the exemplary padlock according to an aspect of the present invention;

FIG. 7 is a perspective view of an exemplary spindle configured for use with the exemplary padlock according to an aspect of the present invention;

FIG. 8 is a perspective view of an exemplary clutch configured for use with the exemplary padlock according to an aspect of the present invention;

FIG. 9 is a perspective view of an exemplary dial configured for use with the exemplary padlock according to an aspect of the present invention;

FIG. 10 is a perspective view of an exemplary reset button configured for use with the exemplary padlock according to an aspect of the present invention;

FIG. 11 is a perspective view of an exemplary reset plate configured for use with the exemplary padlock according to an aspect of the present invention;

FIG. 12 is a perspective view of an exemplary reset control bolt configured for use with the exemplary padlock according to an aspect of the present invention;

FIG. 13A is a partial cross-sectional front view of an exemplary padlock according to an aspect of the invention in an unlocked mode with an exemplary front body side removed;

FIG. 13B is a partial cross-sectional rear view of the exemplary padlock with an exemplary rear body side removed;

FIG. 14A is a partial cross-sectional front view of an exemplary padlock according to an aspect of the invention in a reset mode with an exemplary front body side removed;

FIG. 14B is a partial cross-sectional rear view of the exemplary padlock with an exemplary rear body side removed;

FIG. 15A is a partial cross-sectional front view of another exemplary embodiment of a padlock according to an aspect of the invention in a locked mode with an exemplary front body side removed;

FIG. 15B is a partial cross-sectional rear view of the exemplary padlock with an exemplary rear body side removed; and

FIG. 16 is a perspective view of another exemplary turning know configured for us with the exemplary padlock according to an aspect of the present invention.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

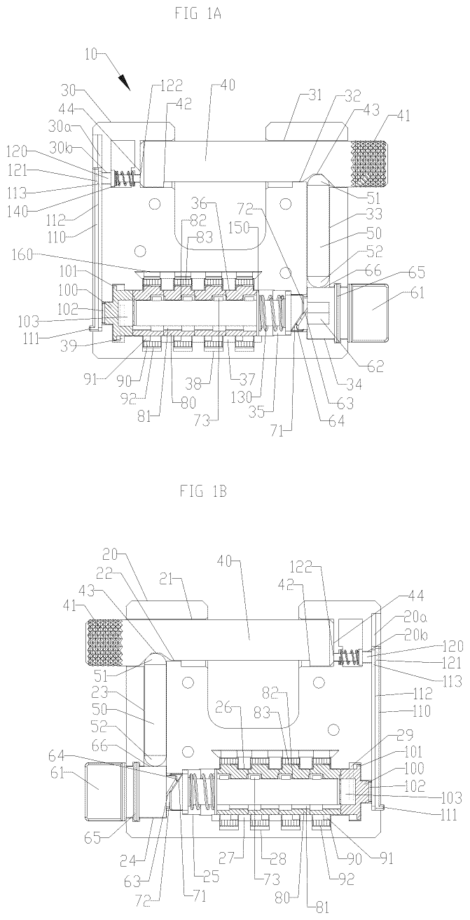

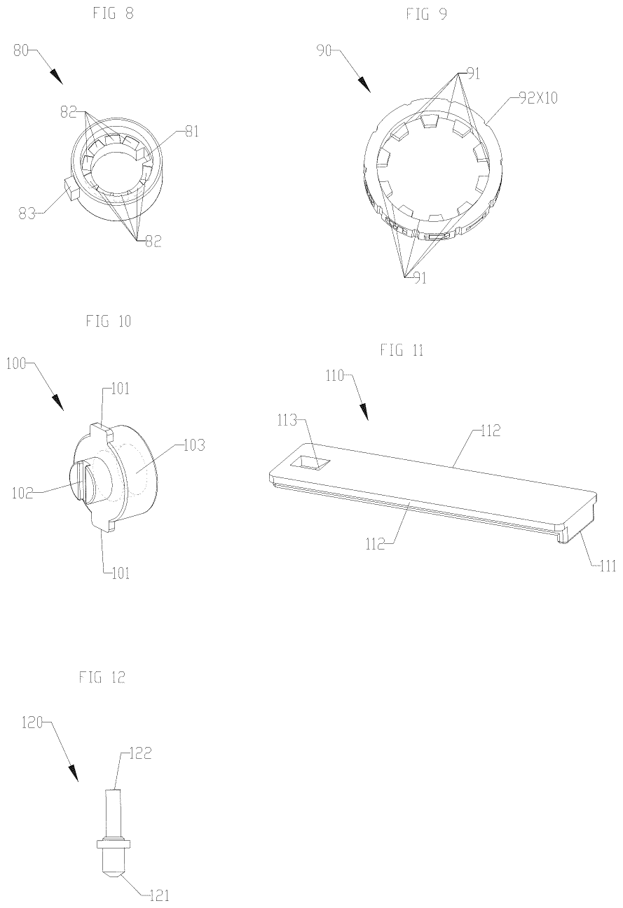

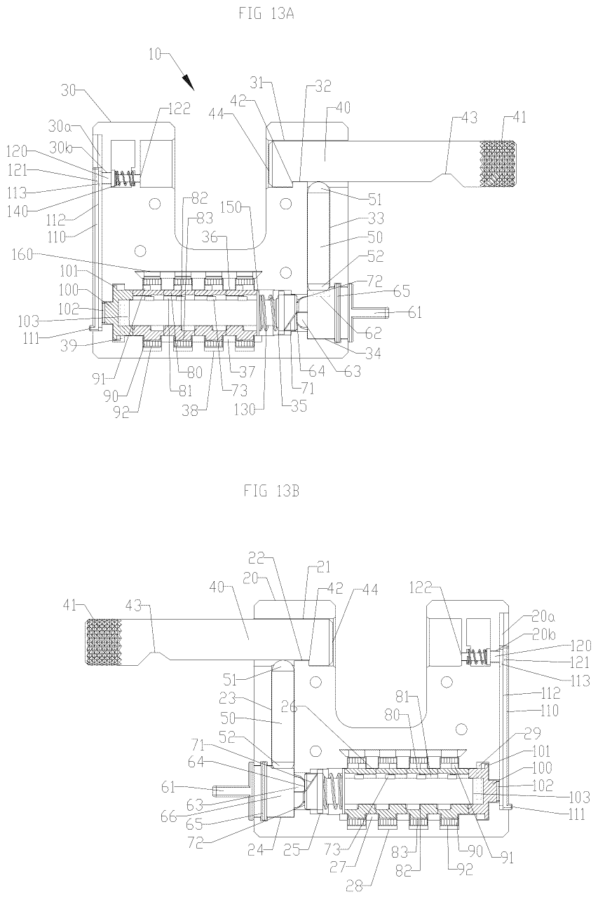

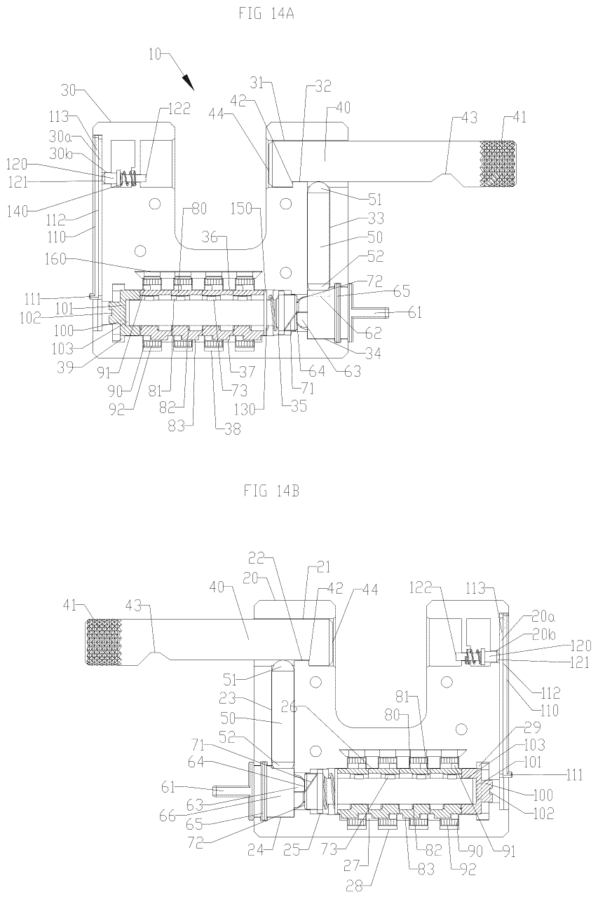

Referring now to FIGS. 1A-1B and 2-12, therein illustrated is an exemplary embodiment of a padlock, generally indicated by reference numeral 10, according to an aspect of the present invention. The padlock 10 may be a combination warehouse lock, and may be comprised of a front body side 20 and a rear body side 30 coupled together to form a lock body configured to at least partially enclose and/or house the components of the padlock 10. The padlock 10 may also include a shackle 40 movable between a position in which the padlock 10 is in a locked mode and a position in which the padlock 10 is in an unlocked mode. The lock body of the padlock 10 formed by the front body side 20 and the rear body side 30 may have a substantially U-shape, and the shackle 40 may be configured to enclose the U-shape when the padlock 10 is in the locked mode, and configured to allow opening of the U-shape when the padlock 10 is in the unlocked mode. The padlock 10 may also include a bolt 50 configured to control movement of the shackle 40, and a turning knob 60 operatively engaged with the bolt 50 and configured to control movement of the bolt 50. The padlock 10 may also include a combination mechanism comprised of a spindle 70, at least one clutch 80 and at least one dial 90. The turning knob 60 may also be a component of the combination mechanism. The combination mechanism is configured to allow operation of the padlock 10 to the unlocked mode when a correct code combination has been selected on the combination mechanism. The padlock 10 may also include a reset button 100 configured to allow operation of the padlock 10 to a reset mode when the padlock 10 has been operated into the unlocked mode in order to allow resetting and/or reconfiguring of the correct code combination.

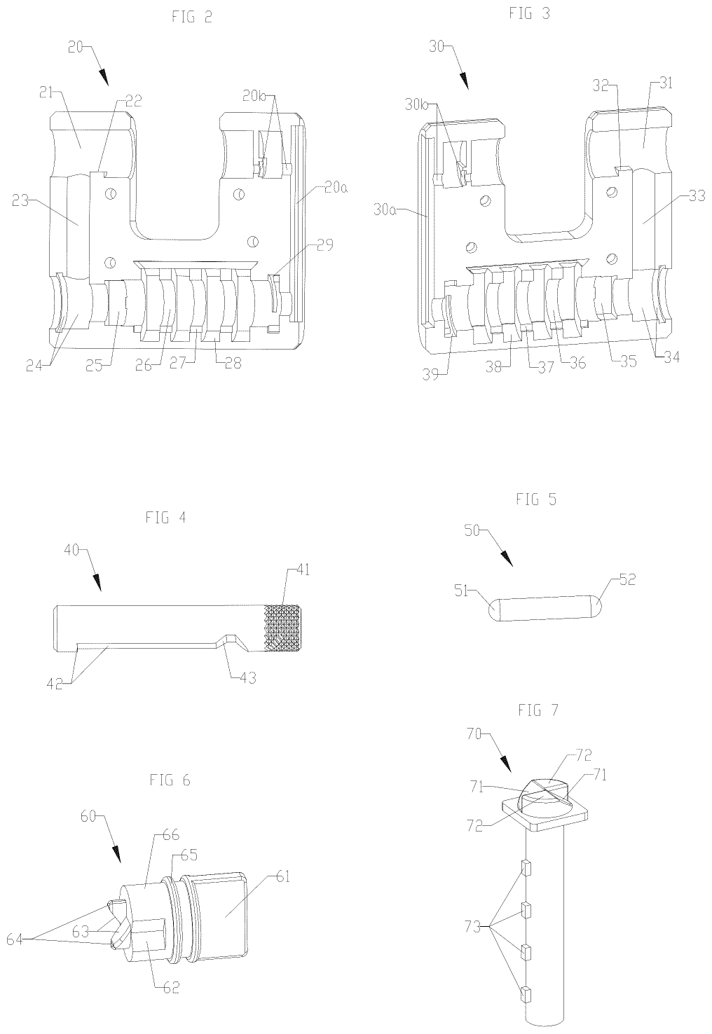

Referring more specifically to FIGS. 2 and 3, the front body side 20 may include a shackle hole 21 formed therein through which the shackle 40 may be slidingly engaged. The front body side 20 may also include a shackle-catcher 22 extending into the shackle hole 21, and configured to facilitate retention of the shackle 40 within the padlock 10. The front body side 20 may also include a bolt-hole 23 at least partially intersecting the shackle hole 21 and configured for receipt of the bolt 50. The front body side 20 may also include a knob-receiving hole 24 configured for at least partial receipt of the turning knob 60 and intersecting with the bolt-hole 23 and a spindle hole 25 extending from the knob-receiving hole 24. The spindle hole 25 is configured for at least partial receipt of the spindle 70. The front body side 20 may also include one or more clutch holes 26, each clutch hole 26 may have an extended-fin cutout 27 formed adjacent thereto, and each of the clutch holes 26 may have a dial hole 28 positioned on either or both sides of the clutch hole 26. The front body side 20 may also include a reset-knob fit slot 29, a reset-plate slot 20a and a recode-bolt cutout 20b. The rear body side 30 may include a shackle hole 31 configured for at least partial receipt of the shackle 40, and complementarily positioned relative to the shackle hole 21 so as to form a bore for the shackle 40 in the padlock 10 when the rear body side 30 is coupled with the front body side 20. The rear body side 30 may also include a shackle-catcher 32 extending into the shackle hole 31. The rear body side 30 may also include a bolt hole 33 configured for at least partial receipt of the bolt 50, and complementarily positioned relative to the bolt hole 23 so as to form a bore for the bolt 50 in the padlock 10 when the rear body side 30 is coupled with the front body side 20. The rear body side 30 may also include a knob-receiving hole 34 configured for at least partial receipt of the turning knob 60, and complementarily positioned relative to the knob-receiving hole 24 so as to form a cavity for the turning knob 60 in the padlock 10 when the rear body side 30 is coupled with the front body side 20. The rear body side 30 may also include a spindle hole 35, at least one clutch hole 36, an extended-fin cutout 37 positioned adjacent to each clutch hole 36 and a dial hole 38 positioned on either or both sides of each clutch hole 36. These are positioned so as to be complementary to the corresponding holes in the front body side 20. The rear body side 30 may also include a reset-knob fit slot 39, a reset-plate slot 30a and a recode-bolt cutout 30b.

Referring again to FIGS. 1A-1B and 2-12, the shackle 40 of the padlock 10 may include a grabbing zone 41, which may be formed from a knurled or other textured surface. The shackle 40 may also include a long-cutout 42 configured for engagement with the shackle-catcher 22/32 so that the shackle 40 is retained in the padlock 10 when the padlock 10 has been operated to the unlocked mode. The shackle 40 may also include a bolt cutout 43 formed therein, and configured for receipt of the bolt 50 when the padlock 10 is in the locked mode. The bolt 50 inhibits and/or prevents movement of the shackle 40 when engaged with the bolt cutout 43. The shackle 40 may also include a tail 44 configured for engagement with a reset-control bolt 120. The bolt 50, which may have a substantially tubular shape, may include a shackle-side 51 configured for engagement with the bolt cutout 43 of the shackle 40, and a knob-side 52 configured for engagement with the turning knob 60. The turning knob 60 may include a grabbing area 61, which is a surface a user of the padlock 10 may hold to transfer rotational movement to the turning knob 60. The turning knob 60 may also include an opening slot 62 formed in a locking surface 66. The opening slot 62 is configured for receipt of the knob-side 52 of the bolt 50 when the padlock 10 is in the unlocked mode. The locking surface 66 of the turning knob 60 restricts movement of the bolt 50 so that the shackle side 51 of the bolt 50 may be retained in the bolt cutout 43 when the padlock 10 is in the locked mode. The turning knob 60 may also include one or more slopes 63 and a flat wall 64 extending from the end of each of the slopes 63. The turning knob 60 may also include one or more knob-bigger diameter 65 to facilitate retention of the turning knob 60 in the padlock 10. The spindle 70 of the padlock 10 may include one or more slopes 71 configured for operative engagement with the slopes 63 of the turning knob 60. In the locked mode, the slopes 71 of the spindle 70 prevent the turning knob 60 from rotating as a result of the engagement between the slopes 71 of the spindle 70 and slopes 63 of the turning knob 60. The spindle 70 may also include one or more flat walls 72 configured for engagement with the flat walls 64 of the turning knob 60. The spindle 70 may further include one or more protrusions 73 for each of the one or more clutches 80 present in the padlock 10. Each of the one or more protrusions 73 are dimensioned so as to be passable through an opening channel 81 of each clutch 80, and configured for at least partial engagement with the one or more false gates 82 of each clutch 80 to provide a false indication as to the correct code combination if the padlock 10 is manipulated by an unauthorized user. Each of the clutches 80 may also include an extended-fin 83 configured for engagement with the one or more teeth 91 of a corresponding dial 90. Each of the dials 90 has one or more indicia, which may be in the form of numbers, symbols, letters, colors or the like, corresponding to each tooth of the teeth 91. For example, in the exemplary embodiment illustrated ten indicia in the form of the numbers 0-9 are illustrated, and each of the dials 90 has ten teeth 91. A ratchet plate 160 may be positioned in the padlock 10 in order to give an indication when a distinct indicia of the combination mechanism has been selected as the ratchet plate 160 will engage with ratchet-feeling cutouts 92 on the dials 90 positioned between each indicia. The reset button 100 of the padlock 10 may include one or more tails 101 extending therefrom, and a slot 102 formed therein. The reset button 100 may also include a spindle-receiving cutout 103 configured to receive an end of the spindle 70.

Still referring to FIGS. 1A-1B and 2-12, the padlock 10 may also include a reset plate 110 having a slide-button 111, a pair of edges 112 and a reset bolt receiving cutout 113 formed therein. The reset-control bolt 120 of the padlock 10 may include a rounded-edge 121 and a shackle-edge 122. The padlock 10 may also include a spindle spring 130 configured to urge the spindle 70 into engagement with the turning knob 60. The padlock 10 may also include a reset-control bolt spring 140, and a separation ring 150 positioned between the spindle spring 130 and the one or more clutches 80.

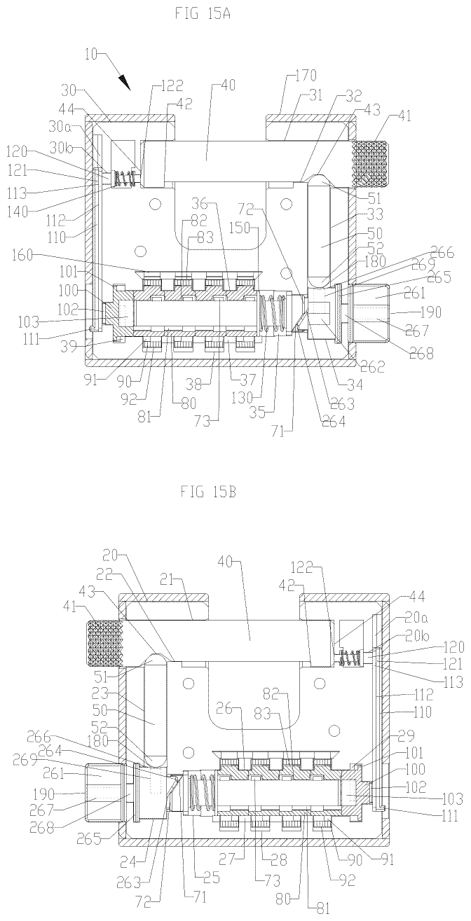

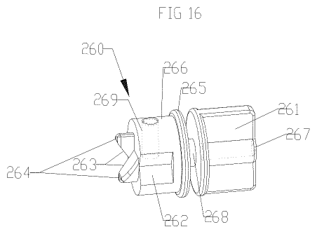

Referring now to FIGS. 15A-15B and 16, an alternative embodiment of the padlock 10 according to the present invention is illustrated. Except as otherwise discussed, the components of the alternative embodiment of the padlock 10 are the same as those discussed with respect to the embodiment illustrated in FIGS. 1A-1B, 2-5 and 7-12. The padlock 10 may include a cover 170 constructed from a hardened material, such as hardened steel, in order to provide resistance to sawing of the padlock 10. The padlock 10 may also include a turning knob 260 having a grabbing area 261, opening slot 262, one or more slopes 263, one or more flat walls 264, one or more knob-bigger diameters 265 and a locking surface 266, all similar in construction and function to the corresponding components of the turning knob 60 (FIG. 6) discussed above. The turning knob 260 may also include an anti-drill peg hole 267 formed in the grabbing area 261 for receipt of an anti-drill peg 190. The turning knob 260 may also include a thinner diameter weaken point 268 providing a weak point in the turning knob 260 such that if the padlock 10 is attempted to be unlocked by the application of force to the turning knob 260, the turning knob 260 will break. The turning knob 260 may also include a reinforcement peg hole 269 formed in the locking surface 266 and configured for receipt of a reinforcement peg 180.

Referring now to FIGS. 1A-1B and 2-12, the locked mode of the padlock 10 will now be discussed. The movement of the shackle 40 and operation of the padlock 10 between the locked mode and the unlocked mode is controlled by the combination mechanism. When the correct code combination has been entered on all of the one or more dials 90, the padlock 10 may be operated from the locked mode to the unlocked mode, and the shackle 40 may move rectilinearly in the lock body of the padlock 10 formed by the front body side 20 and the rear body side 30. When the padlock 10 is in the locked mode, the shackle 40 will have no rectilinear movement and remain in the shackle-hole 21/31 of the front body side 20 and rear body side 30 as the dials 90 are not in the correct code combination. The shackle-side 51 of the bolt 50 engages the bolt cutout 43 of the shackle 40, and prevents movement of the shackle 40. The bolt 50 is unable to move away from the bolt cutout 43, because the knob-side 52 of the bolt 50 is also in contact with locking-surface 66 of the turning knob 60. The one or more slopes 63 of the turning knob 60 are engaged with the one or more slopes 71 of the spindle 70 thereby preventing rotation of the turning knob 60. In the locked mode of the padlock 10, the one or more protrusions 73 of the spindle 70 are not aligned with all of the corresponding one or more opening-channels 81 of the clutches 80, and the user cannot rotate the turning knob 60 to separate the slopes 63 of the turning knob 60 from the slopes 71 of the spindle 70 because the one or more clutches 80 block movement of the spindle 70 as a result of engagement between the one or more clutches 80 and the one or more of the protrusions 73 of the spindle 70. As the spindle 70 remains in the locked mode position turning of the turning knob 60 will be restricted, and the knob-side 52 of the bolt 50 remains in contact with the locking-surface 66 of the turning knob 60. Each of the clutches 80 contain one or more false gates 82 to improve the amount of time required to decode/pick the padlock 10. The extended-fin 83 of each clutch 80 is in contact with the teeth 91 of the corresponding dial 90 so that rotation of one of the dials 90 will directly rotate the corresponding clutch 80 in the same manner. The padlock 10 can be operated to the unlocked mode if all opening-channels 81 of the clutches 80 align to the corresponding protrusions 73 of the spindle 70, and rotation of the turning knob 60 will cause the slopes 63 to disengage from the slopes 71 of the spindle 70 and the flat walls 64 of the turning knob 60 to contact the flat walls 72 of the spindle 70, which allows for rotational separation between the spindle 70 and the turning knob 60 and allows the protrusions 73 of the spindle 70 to travel through the opening-channels 81 of each of the clutches 80. This rotational separation between the turning knob 60 and the spindle 70 allows the turning knob 60 to keep rotating until the opening slot 62 aligns to the knob-side 52 of the bolt 50. Then the bolt 50 can drop into the opening slot 62 and the shackle-side 51 of the bolt 50 will move out of the bolt cutout 43, and there is nothing to block the bolt cutout 43 of the shackle 40. The user can then pull the grabbing-zone 41 of the shackle 40 to pull the shackle 40 outward until the long-cutout 42 of the shackle 40 contacts the shackle-catcher 22/32 of the front body side 20 and rear body side 30. The bolt 50 may be positioned in the bolt-hole 23/33 of the lock body 20/30. The knob-receiving hole 24/34 of the lock body 20/30 is configured to allow the knob-bigger diameter 65 to assemble into the knob-receiving hole 24/34 such that the turning knob 60 will not fall apart from the lock body 20/30 once it is assembled. The spindle hole 25/35 of the lock body allows the spindle 70 to travel through when the spindle 70 is allowed to have rectilinear movement within the lock body. The clutch hole 26/36 of the lock body allows the clutch 80 to travel through when movement of the clutch 80 is allowed, for example during the reset mode. The extended-fin-cutout 27/37 of the lock body 20/30 allows the extended fin 83 of the clutch 80 to be engaged into this cutout 27/37 to allow the padlock 10 to be operated into the reset mode by allowing the dials 90 to turn without causing rotational movement of the corresponding clutches 80 in the reset mode. The dial hole 28/38 is configured to allow the dials 90 to travel through. The reset-knob-fin-slot 29/39 of the lock body 20/30 is for the reset mode, where the reset button 100 will be pushed inward and the tails 101 of the reset button will be engaged into such slot 29/39 and let the user to have both hands free without further continuing to depress the reset button 100 to reset the padlock 10. The reset-plate slot 20a/30a is to receive the reset plate 110 to allow the user to slide the reset plate 110 to allow the user to contact the reset button 100. The recode-bolt-cutout 20b/30b is to assemble the reset-control-bolt 120 to control the movement of the reset-plate 110. The ratchet plate 160 will contact the ratchet-feeling-cutout 92 of each of the dials 90 to make the ratchet feel of for each rotation of the dials 90 between the ratchet-feeling-cutout 92. A separation ring 150 is assembled in between the clutch 80 and the spindle spring 130 and the spindle 70. The separation ring 150 is to prevent the rotation of the clutches 80 from causing rotation of the spindle spring 130 to prevent any torque from being applied to the spring 130.

Referring now to FIGS. 13A-13B, the operation of the padlock 10 to the unlocked mode by the combination mechanism will now be discussed. As discussed above, rotation of each of the dials 90 will rotate the clutch 80 corresponding to the rotating dial 90 in the same manner. The padlock 10 can be operated to the unlocked mode when all opening-channels 81 of the clutches 80 align with the protrusions 73 of the spindle 70, such that the rotation of the turning knob 60 will make the slopes 63 disengage from the slopes 71 of the spindle 70, and the flat walls 64 of the turning knob 60 will contact the flat walls 72 of the spindle 70 which makes the protrusions 73 of the spindle 70 travel through the opening-channel 81 of the clutch 80 to allow the turning knob 60 to keep rotating until the opening slot 62 aligns to the knob-side 52 of the bolt 50. The flat-wall 72 of the spindle 70 will contact the flat wall 64 of the turning knob 60 such that the turning knob 60 can be retained in this position, and will not rotate to the locked mode position after the spindle 70 has been rotationally separated from the turning knob 60. The bolt 50 will drop downward into the opening slot 62, and the shackle-side 51 of the bolt 50 will move downward and there is nothing to block the bolt cutout 43 of the shackle 40. The user could then pull the grabbing-zone 41 of the shackle 40 to pull the shackle 40 outward until the long-cutout 42 of the shackle 40 contacts the shackle-catcher 22/32 of the body 20/30. The long-cutout 42 of the shackle is not deep enough for the bolt 50 to travel from the unlocked mode position back to the locked mode position. It will jam the turning knob 60 to disallow the knob 60 to rotate back to the locked position. To relock the padlock 10 and return the padlock 10 to the locked mode, the user could push the shackle 40 back to the locked mode position such that the bolt cutout 43 aligns to the bolt 50. As they align, the shackle side 51 of the bolt 50 will be able to engage to the bolt cutout 43 of the shackle 40. The user could rotate the turning knob 60 such that the bolt 50 will slide out of the opening slot 62 and urge the knob-side 52 of the bolt 50 away from the opening slot 62, so that the knob-side 52 of the bolt 50 will contact the locking-surface 66 of the turning knob 60 and the shackle-side 51 of the bolt 50 will be fully engaged back to the bolt-cutout 43 of the shackle 40.

Referring now to FIGS. 14A-14B, the reset mode of the padlock 10 will now be discussed. In the reset mode, the user must operate the padlock 10 to the unlocked mode via the combination mechanism as described above. Once the padlock 10 is in the unlocked mode, the shackle 40 is pulled away to the unlocked mode position, and the tail 44 of the shackle 40 will no longer contact the shackle-edge 122 of the reset-control-bolt 120. Then, the user could pull the slide-button 111 to slide the reset plate 110 upward such that the rounded-edge 121 of the reset-control-bolt 120 will move away from the reset-bolt-receiving-cutout 113 of the reset plate 110. The reset plate contains edges 112, which are assembled to the reset-plate slot 20a/30a of the lock body 20/30 such that the reset plate 110 could only slide upward/downward without moving in any other direction. As the reset plate 110 is being pushed upward, the reset button 100 is now exposed and allows the user to push the reset button 100 inward for the reset mode. As the user pushes the reset button 100 inward, the tails 101 will align to the reset-knob-fin-slot 29/39 of the lock body 20/30. The user can then rotate the reset button 100 such that the tail 101 will engage to the reset-knob-fin-slot 29/39 and this will make the reset button 100 be pushed rightward toward the spindle 70. The reset button 100 will rest in the reset mode and allow the user to have both hands free to rotate the dials 90 to reset and/or reconfigure the correct code combination. As the reset button 100 is being pushed rightward, the clutches 80 will also be pushed rightward and the extended-fin 83 of the clutch 80 will engage to the extended-fin-cutout 27/37 of the lock body 20/30. The protrusion 73 of the spindle 70 is in the opening-channel 81 of the clutch 80 and in such engagement position, the extended fin 83 of the clutch 80 is disengaged from the teeth 91 of the dials 90. The user rotates the dials 90 to set a new correct code combination. The rotation of the dials 90 will not rotate the clutch 80 in the reset mode. After setting, the user could counter rotate the reset button 100 such that the tails 101 disengage from the reset-knob-fin-slot 29/39, the spindle spring 130 will push the separation ring 150 and the clutches 80 leftward such that the extended fin 83 will move away from the extended-fin-cutout 27/37. The extended fin 83 will engage back to the teeth 91 of the dials 90. The spindle spring 130 will push the clutch 80 and the reset button 100 leftward back to the original position.

The user could then slide the reset plate 110 downward to cover the reset button 100 to prevent the user from accidentally changing the correct code combination. The reset bolt-receiving-cutout 113 will align to the rounded-edge 121 of the reset-control-bolt 120 and reset-control-bolt-spring 140 will exert force to urge the rounded-edge 121 of the reset-control-bolt 120 to engage into the reset-bolt-receiving-cutout 113 of the reset plate 110. The shackle-edge 122 of the reset-control-bolt 120 will now be hidden away, and the shackle 40 is able to move back to the locked mode position as the shackle-edge 122 will not be blocking the shackle 40 from moving back to the locked mode position. In the reset mode, when the reset plate 110 has been slid upward, the shackle-edge 122 of the reset-control-bolt 120 is extended rightward such that if the user pushes the shackle 40 back to the locked mode position, the tail 44 of the shackle 40 will contact the shackle-edge 122 of the reset-control-bolt 120 which will make the shackle 40 not completely lock which will alert the user that the reset plate 110 is still in reset position and the user must push the reset plate 110 downward such that the shackle-edge 122 will no longer contact the tail 44 of the shackle 40 allowing the shackle 40 to lock completely.

Referring now to FIGS. 15A-15B and 16, an alternative embodiment of the padlock 10 according to an aspect of the present invention is shown. The padlock 10 may include the cover 170 assembled to the padlock 10 and formed from hardened steel to provide better weather protection and protection and/or resistance to a sawing attack. The cover 170 may be added to the padlock 10 regardless of whether the padlock 10 also includes the alternative embodiment of the turning knob 260. The turning knob 260 has substantially the same function and construction as the turning knob 60, but may also include the anti-drill peg hole 267 which is to allow the anti-drill peg 190 to be assembled into the turning knob 206 to prevent and/or inhibit an intruder from drill the turning knob 260 from outside The turning knob 260 also includes the thinner diameter weaken point 268 such that a force turning of the turning knob 260 in the locked mode, this weaken point 268 will break apart internally and protects the spindle 70 from being forced turned and opening the padlock 10. The turning knob 260 may also include the reinforcement peg hole 269 which is to assembled the reinforcement peg 180 and this hardened reinforcement peg 180 will contact the bolt 50 to improve the contact strength between the bolt 50 and the peg 180.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed:

1. A padlock, comprising:
a lock body having a front body side and a rear body side configured to form an enclosure for at least a portion of the padlock;
a shackle moveable between a locked mode position and an unlocked mode position, wherein when the shackle is in the locked mode position the padlock is in a locked mode, and wherein when the shackle is in the unlocked mode position the padlock is in an unlocked mode;
a combination mechanism comprising a set of clutches wherein each clutch of the set of clutches comprises a plurality of false gates and at least one opening channel;
wherein the combination mechanism further comprises a dial operatively connected to each clutch the set of clutches;
wherein the combination mechanism further comprises a spindle having at least one protrusion for each clutch of the set of clutches, wherein the at least one opening channel of each clutch is configured to control movement of the spindle allowing each protrusion of the spindle to pass at least partially through the opening channel of the corresponding clutch to operate the padlock to the unlocked mode or inhibiting movement of at least one of the one or more of the protrusions by at least one of the false gates of a clutch corresponding to the at least one protrusion;
a bolt having one end configured to engage to the shackle and the other end configured to engage the combination mechanism.

2. The padlock according to claim 1, wherein the padlock combination mechanism further comprises a turning knob operatively coupled to the spindle and configured for rotational movement at least partially within the lock body of the padlock, and wherein the turning knob is further configured to allow movement of the shackle from the locked mode position to the unlocked mode position.

3. The padlock according to claim 2, wherein the turning knob comprises one or more knob slopes and the spindle comprises one or more spindle slopes configured to engage with the one or more knob slopes of the turning knob when the padlock is in the locked mode, wherein rotation of the turning knob is configured to disengage the one or more knob slopes of the turning knob from the one or more spindle slopes of the spindle and cause rectilinear movement of the spindle in a spindle direction substantially parallel to an axis of rotation of the turning knob.

4. The padlock according to claim 3, wherein when the opening-channel of each of the clutches are fully aligned with the corresponding protrusions of the spindle each protrusion of the spindle is configured to pass at least partially through the opening channel of the corresponding clutch to operate the padlock to the unlocked mode.

5. The padlock according to claim 3, wherein if at least one of the opening channels are not aligned to the corresponding protrusions of the spindle, then the turning knob cannot cause rectilinear movement of the spindle in the spindle direction as a result of interaction between the slopes of the turning knob and the spindle.

6. The padlock according to claim 3, wherein the turning knob further comprises an opening slot configured to receive the other end of the bolt that is configured to engage the combination mechanism, wherein when the other end of the bolt is received within the opening slot of the turning knob the bolt end configured to engage to the shackle is disengaged from a bolt-cutout of the shackle, whereby the shackle may be moved rectilinearly from the locked mode position to the unlocked mode position.

7. The padlock according to claim 6, wherein the opening slot of the turning knob is formed in a locking surface of the knob, wherein in the locked mode of the padlock the locking surface is engaged with the other end of the bolt, and wherein when the turning knob is rotated the opening slot is configured for engagement with the other end of the bolt so as to allow operation of the padlock to the unlocked mode.

8. The padlock according to claim 3, wherein the spindle further comprises a spindle flat wall formed on an end of each of the spindle slopes, and wherein the turning knob further comprises a turning knob flat wall formed on an end of each of the knob slopes, wherein disengagement of the one or more knob slopes of the turning knob from the one or more spindle slopes of the spindle and cause engagement between the corresponding spindle flat walls and the turning knob flat walls and rectilinear movement of the spindle in the spindle direction.

9. The padlock according to claim 1, further comprising a reset button configured to control the padlock from the unlocked mode to a reset mode, wherein the reset button comprises at least one tail configured to engage to a reset-knob-fin-slot of the lock body such that a user of the padlock could have both hands free from depressing the reset button while the padlock is in the reset mode.

10. The padlock according to claim 9, wherein when the padlock is in the reset mode, the reset button is configured for depression and rotation so as to allow the at least one tail to engage to the reset-knob-fin-slot of the lock body, wherein depression of the reset button is configured to cause disengagement of each of the extended fins of each of the clutches from the teeth of the dials and engagement of each of the extended fins to a corresponding extended fin cutout in the lock body to prevent any rotational movement of the clutches.

11. The padlock according to claim 9, further comprising a reset plate assembled to the lock body, wherein the reset plate is configured to cover up the reset button to avoid accidental change of a correct code combination of the combination mechanism, and to prevent the padlock from being decoded by depressing the reset button to trying to decode the correct code combination.

12. The padlock according to claim 11, further comprising a reset-control-bolt configured for engagement with the shackle when the shackle is in the locked mode position, and wherein the reset plate contains a reset bolt-receiving-cutout to receive the reset-control-bolt to control the movement of the reset plate.

13. The padlock according to claim 12, wherein when the shackle is in the locked mode position a shackle-edge of the reset-control-bolt is configured to contact the shackle, and the reset-control-bolt is configured to engage to the reset bolt-receiving cutout of the reset plate to prevent the reset plate from being moved to expose the reset button.

14. The padlock according to claim 12, wherein when the shackle is in the unlocked mode position a shackle-edge of the reset-control-bolt is configured to move in a direction towards the shackle when the reset plate is moved to expose the reset button, and a rounded-edge of the reset-control bolt is configured to be disengaged from the reset bolt-receiving-cutout of the reset plate when the reset plate is moved to expose the reset button.

15. The padlock according to claim 12, wherein the reset plate can only be moved when the padlock is in the unlocked mode and the shackle is in the unlocked mode position, wherein the reset-control bolt is configured for movement in a direction substantially parallel to the movement of the shackle from the locked mode position to the unlocked mode position, and the reset plate is configured for movement in a direction substantially perpendicular to the movement of the shackle from the locked mode position to the unlocked mode position.

16. The padlock according to claim 10, wherein after resetting of a correct code combination of the combination mechanism of the padlock, the reset button is released, then the user could slide the reset plate from a reset state back to a lock state then a reset bolt-receiving-cutout from the reset plate will align back to a rounded-edge of a reset-control-bolt, wherein the reset-control-bolt has a spring which will urge the rounded-edge toward the reset bolt-receiving-cutout, wherein when the shackle is operated from the unlocked mode position to the locked mode position a tail of the shackle is configured to contact a shackle-edge of the reset-control bolt to cause engagement of the rounded-edge of the reset-control bolt with the reset bolt-receiving-cutout.

17. The padlock according to claim 10, wherein when the padlock is in the reset mode, after resetting and/or reconfiguring the correct code combination the user can rotate the reset button counter rotation to let the tail of the reset button disengage from the reset-knob-fin-slot of the lock body and a spindle spring will force the clutches and the reset button back from a reset mode position to an unlocked mode position, and wherein the new correct code combination has been set when the reset plate is in the unlocked mode position and the shackle is in the unlocked mode position.

18. The padlock according to claim 6, wherein the padlock may be operated from the unlocked mode to the reset mode when the bolt is engaged to the opening slot of the turning knob to allow the shackle to be in the unlocked mode position allowing a reset-control-bolt to move rectilinearly and a reset plate to be slid open exposing a reset button.

19. The padlock according to claim 2, wherein the turning knob further comprises:
an anti-drill peg hole configured for receipt of an anti-drill peg, and the anti-drill peg is configured to resist drilling of the turning knob from outside;
a thinner diameter weaken point such that a force applied to the turning knob in the locked mode, will cause the thinner diameter weaken point to break apart protecting the spindle from being forced to turn and operate the padlock to the unlocked mode; and
a reinforcement peg hole for receipt of a reinforcement peg, wherein the hardened reinforcement peg will contact the bolt to improve the contact strength between the bolt and the reinforcement peg.

20. The padlock according to claim 1, further comprising a protection cover formed from a hardened steel material configured to resist a sawing attack, wherein the protection cover at least partially encloses the front body side and the rear body side of the padlock.
